(19) United States
(12) Patent Application Publication
(10) Pub. No.: US 2016/0313684 A1
(43) Pub. Date: Oct. 27, 2016

(54) HEATER, FIXING DEVICE, AND IMAGE FORMING APPARATUS

(71) Applicant: Tamotsu Ikeda, Kanagawa (JP)

(72) Inventor: Tamotsu Ikeda, Kanagawa (JP)

(73) Assignee: Ricoh Company, Ltd., Tokyo (JP)

(21) Appl. No.: 15/092,206

(22) Filed: Apr. 6, 2016

(30) Foreign Application Priority Data
Apr. 24, 2015 (JP) 2015089339

(51) Int. Cl. H05B 3/00; G03G 15/20

(52) U.S. Cl. CPC G03G 15/2057

(57) ABSTRACT

A heater includes a tubular bulb and a filament disposed inside the bulb and extended in a longitudinal direction of the bulb. A first metallic foil is coupled to one lateral end of the filament in the longitudinal direction of the bulb. A second metallic foil is coupled to another lateral end of the filament in the longitudinal direction of the bulb. A first wire is coupled to the first metallic foil at a first contact. The first wire extends from the first contact in an intersecting direction intersecting the longitudinal direction of the bulb. A second wire is coupled to the second metallic foil at a second contact.

### CROSS-REFERENCE TO RELATED APPLICATION

This patent application is based on and claims priority pursuant to 35 U.S.C. §119 to Japanese Patent Application No. 2015-089339, filed on Apr. 24, 2015, in the Japanese Patent Office, the entire disclosure of which is hereby incorporated by reference herein.

### BACKGROUND

1. Technical Field

Exemplary aspects of the present disclosure relate to a heater, a fixing device, and an image forming apparatus, and more particularly, to a heater, a fixing device incorporating the heater to fix a toner image on a recording medium, and an image forming apparatus incorporating the fixing device.

2. Description of the Background

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such fixing device may include a fixing rotator, such as a fixing roller, a fixing belt, and a fixing film, heated by a heater and a pressure rotator, such as a pressure roller and a pressure belt, pressed against the fixing rotator to form a fixing nip therebetween through which a recording medium bearing a toner image is conveyed. As the recording medium bearing the toner image is conveyed through the fixing nip, the fixing rotator and the pressure rotator apply heat and pressure to the recording medium, melting and fixing the toner image on the recording medium.

The heater that heats the fixing rotator may be a halogen heater. The halogen heater may also be installed in a dehumidifier that dehumidifies the recording medium placed on a paper tray incorporated in the image forming apparatus.

### SUMMARY

This specification describes below an improved heater. In one exemplary embodiment, the heater includes a tubular bulb and a filament disposed inside the bulb and extended in a longitudinal direction of the bulb. A first metallic foil is coupled to one lateral end of the filament in the longitudinal direction of the bulb. A second metallic foil is coupled to another lateral end of the filament in the longitudinal direction of the bulb. A first wire is coupled to the first metallic foil at a first contact. The first wire extends from the first contact in an intersecting direction intersecting the longitudinal direction of the bulb. A second wire is coupled to the second metallic foil at a second contact.

This specification further describes an improved fixing device. In one exemplary embodiment, the fixing device includes a fixing rotator rotatable in a predetermined direction of rotation, a pressure rotator pressed against the fixing rotator to form a fixing nip therebetween, through which a recording medium bearing a toner image is conveyed, and a heater to heat the fixing rotator. The heater includes a tubular bulb and a filament disposed inside the bulb and extended in a longitudinal direction of the bulb. A first metallic foil is coupled to one lateral end of the filament in the longitudinal direction of the bulb. A second metallic foil is coupled to another lateral end of the filament in the longitudinal direction of the bulb. A first wire is coupled to the first metallic foil at a first contact. The first wire extends from the first contact in an intersecting direction intersecting the longitudinal direction of the bulb. A second wire is coupled to the second metallic foil at a second contact.

This specification further describes an improved image forming apparatus. In one exemplary embodiment, the image forming apparatus includes an image forming device to form a toner image and a fixing device disposed downstream from the image forming device in a recording medium conveyance direction to fix the toner image on a recording medium. The fixing device includes a fixing rotator rotatable in a predetermined direction of rotation, a pressure rotator pressed against the fixing rotator to form a fixing nip therebetween, through which the recording medium bearing the toner image is conveyed, and a heater to heat the fixing rotator. The heater includes a tubular bulb and a filament disposed inside the bulb and extended in a longitudinal direction of the bulb. A first metallic foil is coupled to one lateral end of the filament in the longitudinal direction of the bulb. A second metallic foil is coupled to another lateral end of the filament in the longitudinal direction of the bulb. A first wire is coupled to the first metallic foil at a first contact. The first wire extends from the first contact in an intersecting direction intersecting the longitudinal direction of the bulb. A second wire is coupled to the second metallic foil at a second contact.

### BRIEF DESCRIPTION OF THE DRAWINGS

A more complete appreciation of the disclosure and the many attendant advantages thereof will be readily obtained as the same becomes better understood by reference to the following detailed description when considered in connection with the accompanying drawings, wherein:

FIG. 1 is a schematic vertical cross-sectional view of an image forming apparatus according to an exemplary embodiment of the present disclosure;

FIG. 2 is a schematic vertical cross-sectional view of a fixing device incorporated in the image forming apparatus illustrated in FIG. 1;

FIG. 3 is a schematic perspective view of a first comparative heater;

FIG. 4 is a schematic perspective view of a second comparative heater;

FIG. 5 is a schematic perspective view of a third comparative heater;

FIG. 6 is a schematic cross-sectional view of a heater according to an exemplary embodiment of the present disclosure that is incorporated in the fixing device illustrated in FIG. 2;

FIG. 7A is a schematic cross-sectional view of the second comparative heater illustrated in FIG. 4 for explaining a first comparison;

FIG. 7B is a schematic cross-sectional view of the heater illustrated in FIG. 6 for explaining the first comparison;

FIG. 8A is a schematic cross-sectional view of the second comparative heater illustrated in FIG. 4 for explaining a second comparison;

FIG. 8B is a schematic cross-sectional view of the heater illustrated in FIG. 6 for explaining the second comparison;

FIG. 9 is a schematic cross-sectional view of a heater according to another exemplary embodiment of the present disclosure;

FIG. 10A is a schematic cross-sectional view of the third comparative heater illustrated in FIG. 5 for explaining a third comparison;

FIG. 10B is a schematic cross-sectional view of the heater illustrated in FIG. 9 for explaining the third comparison;

FIG. 11A is a schematic cross-sectional view of the third comparative heater illustrated in FIG. 5 for explaining a fourth comparison; and

FIG. 11B is a schematic cross-sectional view of the heater illustrated in FIG. 9 for explaining the fourth comparison.

### DETAILED DESCRIPTION OF THE DISCLOSURE

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner and achieve a similar result.

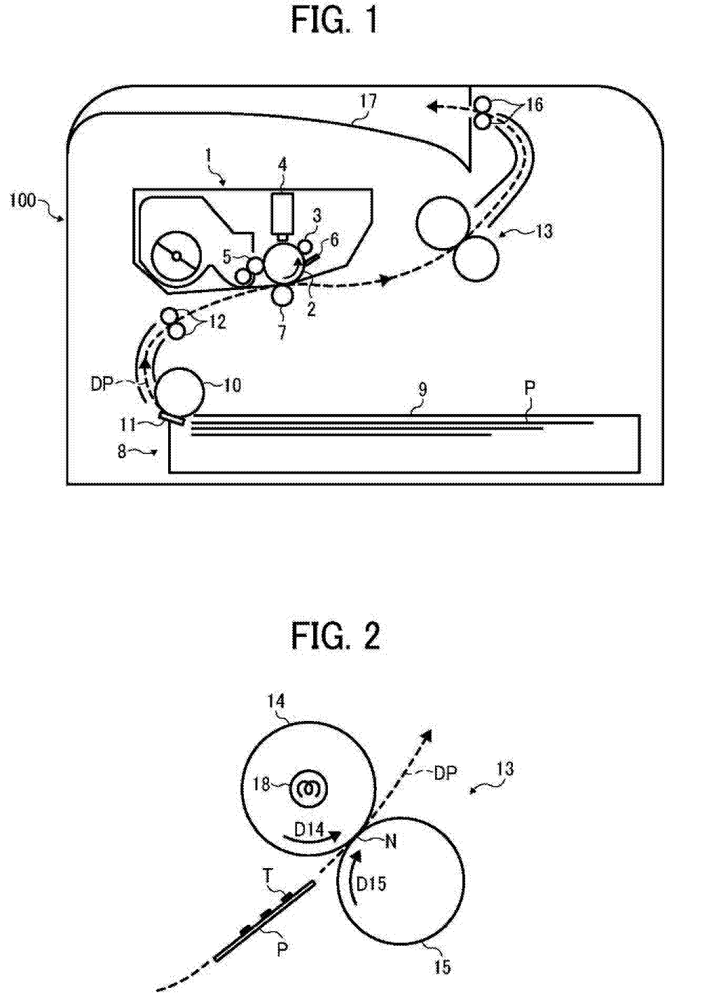

Referring now to the drawings, wherein like reference numerals designate identical or corresponding parts throughout the several views, in particular to FIG. 1, an image forming apparatus 100 according to an exemplary embodiment of the present disclosure is explained.

It is to be noted that, in the drawings for explaining exemplary embodiments of this disclosure, identical reference numerals are assigned, as long as discrimination is possible, to components such as members and component parts having an identical function or shape, thus omitting description thereof once it is provided.

FIG. 1 is a schematic vertical cross-sectional view of the image forming apparatus 100. The image forming apparatus 100 may be a copier, a facsimile machine, a printer, a multifunction peripheral or a multifunction printer (MFP) having at least one of copying, printing, scanning, facsimile, and plotter functions, or the like. According to this exemplary embodiment, the image forming apparatus 100 is a monochrome image forming apparatus that forms a monochrome toner image on a recording medium by electrophotography. Alternatively, the image forming apparatus 100 may be a color image forming apparatus that forms a color toner image on a recording medium.

It is to be noted that, in the drawings for explaining exemplary embodiments of this disclosure, identical reference numerals are assigned as long as discrimination is possible to components such as members and component parts having an identical function or shape, thus omitting description thereof once it is provided.

Referring to FIG. 1, a description is provided of a construction of the image forming apparatus 100.

The image forming apparatus 100 is a monochrome image forming apparatus for forming a monochrome toner image on a recording medium by electrophotography. Alternatively, the image forming apparatus 100 may be a color image forming apparatus for forming color and monochrome toner images on a recording medium. The image forming apparatus 100 includes a process unit 1 (e.g., an image forming unit) serving as an image forming device detachably installed in an apparatus body of the image forming apparatus 100. The process unit 1 includes a drum-shaped photoconductor 2, a charging roller 3, an optical writing head 4, a developing roller 5, and a cleaning blade 6. The photoconductor 2 serves as an image bearer or a latent image bearer that bears an electrostatic latent image and a resultant toner image. The charging roller 3 serves as a charger that charges an outer circumferential surface of the photoconductor 2. The optical writing head 4 serves as an exposure device that exposes the charged outer circumferential surface of the photoconductor 2 to form an electrostatic latent image on the photoconductor 2. The developing roller 5 serves as a developing device that visualizes the electrostatic latent image formed on the outer circumferential surface of the photoconductor 2 as a visible toner image. The cleaning blade 6 serves as a cleaner that cleans the outer circumferential surface of the photoconductor 2.

The process unit 1 further includes a support that collectively supports the photoconductor 2, the charging roller 3, the optical writing head 4, the developing roller 5, and the cleaning blade 6. Hence, as the process unit 1 is detached from the image forming apparatus 100, the photoconductor 2, the charging roller 3, the optical writing head 4, the developing roller 5, and the cleaning blade 6 are removed from the image forming apparatus 100 collectively for replacement.

A transfer roller 7 serving as a transferor is disposed opposite the photoconductor 2 to transfer the toner image formed on the photoconductor 2 onto a sheet P serving as a recording medium. While the process unit 1 is attached to the image forming apparatus 100, the transfer roller 7 contacts the photoconductor 2 to form a transfer nip therebetween. The transfer roller 7 is applied with a predetermined direct current (DC) voltage and/or alternating current (AC) voltage.

A sheet feeder 8 is disposed in a lower portion of the image forming apparatus 100. The sheet feeder 8 includes a paper tray 9, a feed roller 10, and a separation pad 11. The paper tray 9 serves as a recording medium container that loads a plurality of sheets P serving as recording media. The feed roller 10 serves as a recording medium feeder that picks up and feeds an uppermost sheet P of the plurality of sheets P loaded on the paper tray 9. The separation pad 11 serves as a recording medium separator that presses against the feed roller 10 to form a feed nip therebetween and separates the uppermost sheet P from other sheets P. The sheets P may be thick paper, postcards, envelopes, plain paper, thin paper, coated paper, art paper, tracing paper, and the like. Further, the sheets P may be overhead projector (OHP) transparencies (e.g., a sheet and film), fabric, and the like.

The sheet P picked up from the sheet feeder 8 is conveyed through a conveyance path disposed inside the image forming apparatus 100 in a sheet conveyance direction DP. The conveyance path is provided with a timing roller pair 12 (e.g., a registration roller pair) disposed downstream from the feed roller 10 and upstream from the transfer roller 7 in the sheet conveyance direction DP. The timing roller pair 12 serves as a recording medium conveyor that conveys the sheet P conveyed from the feed roller 10 toward the transfer nip at a proper time when the toner image formed on the photoconductor 2 reaches the transfer nip. As the sheet P is conveyed through the transfer nip, the transfer roller 7 transfers the toner image formed on the photoconductor 2 onto the sheet P.

The conveyance path is further provided with a fixing device 13 disposed downstream from the transfer roller 7 in the sheet conveyance direction DP. The fixing device 13 fixes the toner image on the sheet P. The conveyance path is further provided with an output roller pair 16 disposed downstream from the fixing device 13 in the sheet conveyance direction DP. The output roller pair 16 serves as a recording medium ejection device that ejects the sheet P bearing the fixed toner image onto an outside of the image forming apparatus 100. An output tray 17 disposed atop the image forming apparatus 100 stocks the sheet P ejected by the output roller pair 16.

Referring to FIG. 1, a description is provided of an image forming operation performed by the image forming apparatus 100 having the construction described above to form a toner image on a sheet P.

As a print job starts, a driver drives and rotates the photoconductor 2 counterclockwise in FIG. 1. The charging roller 3 uniformly charges the outer circumferential surface of the photoconductor 2 at a predetermined polarity. The optical writing head 4 emits light onto the charged outer circumferential surface of the photoconductor 2 according to image data sent from a scanner or an external device such as a client computer, thus forming an electrostatic latent image on the charged outer circumferential surface of the photoconductor 2. The developing roller 5 supplies toner to the electrostatic latent image formed on the photoconductor 2, visualizing the electrostatic latent image into a visible toner image.

On the other hand, as the print job starts, the feed roller 10 is driven and rotated to pick up and feed an uppermost sheet P of the plurality of sheets P loaded on the paper tray 9 toward the timing roller pair 12 situated in the conveyance path. The timing roller pair 12 halts the sheet P temporarily. Thereafter, the timing roller pair 12 resumes rotation at a predetermined time to convey the sheet P to the transfer nip at a time when the toner image formed on the photoconductor 2 reaches the transfer nip.

The transfer roller 7 is applied with a transfer voltage having a polarity opposite a polarity of the charged toner of the toner image formed on the photoconductor 2, thus creating a transfer electric field at the transfer nip. The transfer electric field transfers the toner image formed on the photoconductor 2 onto the sheet P. After the transfer of the toner image from the photoconductor 2 onto the sheet P, the cleaning blade 6 removes residual toner failed to be transferred onto the sheet P and therefore remaining on the photoconductor 2 therefrom.

Thereafter, the sheet P bearing the toner image is conveyed to the fixing device 13 that fixes the toner image on the sheet P. The sheet P bearing the fixed toner image is ejected by the output roller pair 16 onto the output tray 17.

Referring to FIG. 2, a description is provided of a construction of the fixing device 13 incorporated in the image forming apparatus 100 having the construction described above.

FIG. 2 is a schematic vertical cross-sectional view of the fixing device 13. As illustrated in FIG. 2, the fixing device 13 (e.g., a fuser or a fusing unit) includes two rotators, that is, a fixing roller 14 serving as a fixing rotator or a fixing member rotatable in a rotation direction D14 and a pressure roller 15 serving as a pressure rotator or a pressure member rotatable in a rotation direction D15. The pressure roller 15 contacts the fixing roller 14 to form a fixing nip N therebetween. The fixing device 13 further includes a heater 18 disposed inside the fixing roller 14.

A detailed description is now given of a construction of the fixing roller 14.

The fixing roller 14 is a tube constructed of a heat conductive base layer and a release layer coating the base layer. The heat conductive base layer is made of a material having a desired mechanical strength and an increased thermal conductivity such as carbon steel and aluminum. The release layer constituting an outer circumferential surface of the fixing roller 14 is made of a material that has an increased thermal conductivity and an increased durability and facilitates separation of toner of a toner image Ton the sheet P from the fixing roller 14. For example, the release layer as a coating layer is a tube made of fluoroplastic such as tetrafluoroethylene-perfluoroalkylvinylether copolymer (PFA), a coating with fluoroplastic (e.g., PFA or polytetrafluoroethylene (PTFE)), a silicone rubber layer, and a fluorine rubber layer, or the like. The heater 18 serving as a heater or a heat source is disposed inside the fixing roller 14 to heat the fixing roller 14.

A detailed description is now given of a construction of the pressure roller 15.

The pressure roller 15 is a tube constructed of a cored bar, an elastic layer coating an outer circumferential surface of the cored bar, and a coating layer coating the elastic layer. For example, the cored bar is an STKM carbon steel tube for machine structural purposes or the like. The elastic layer is made of silicone rubber, fluorine rubber, or a foam of those. The coating layer is a heat resistant fluoroplastic tube that facilitates separation of the sheet P from the pressure roller 15 such as PFA and PTFA. A pressurization mechanism (e.g., a spring) biases and presses the pressure roller 15 against the fixing roller 14.

A description is provided of a fixing operation performed by the fixing device 13 having the construction described above.

As a print job starts, the heater 18 is supplied with power, heating the fixing roller 14. A driver starts driving and rotating the fixing roller 14 and the pressure roller 15 in the rotation directions D14 and D15, respectively.

A sheet P bearing an unfixed toner image T transferred from the photoconductor 2 depicted in FIG. 1 enters the fixing nip N formed between the fixing roller 14 and the pressure roller 15. As the sheet P bearing the unfixed toner image T is conveyed through the fixing nip N, the fixing roller 14 and the pressure roller 15 fix the toner image T on the sheet P under heat and pressure. Thereafter, the sheet P bearing the fixed toner image T is ejected from the fixing nip N and ejected onto the outside of the image forming apparatus 100, that is, the output tray 17 depicted in FIG. 1.

A description is provided of a construction of a plurality of comparative heaters.

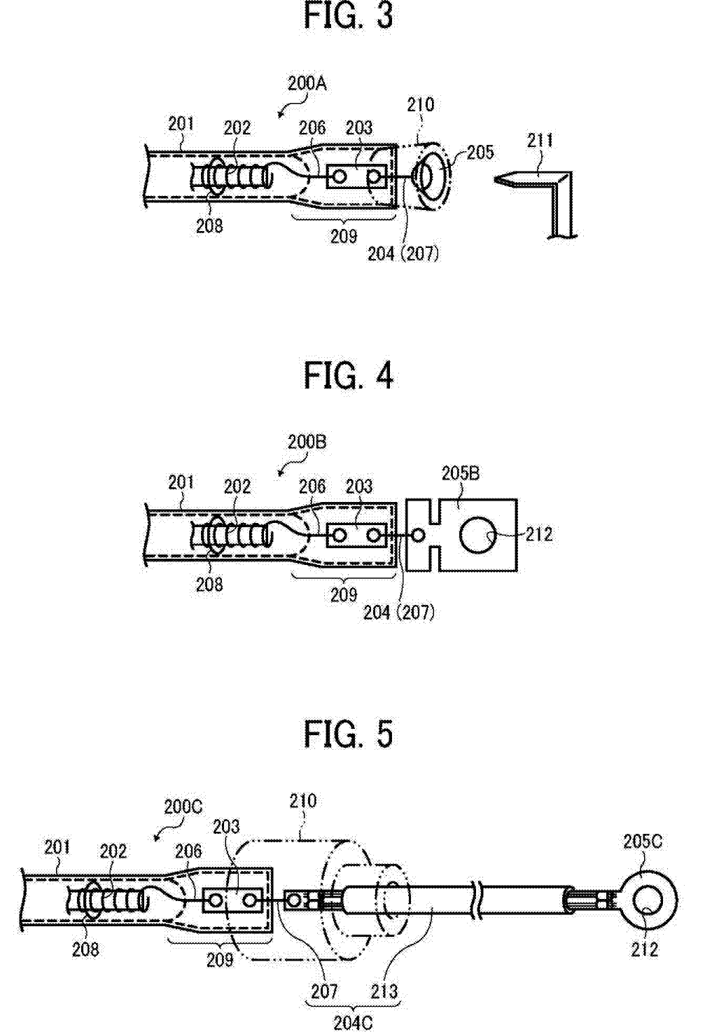

FIG. 3 is a schematic perspective view of a first comparative heater 200A. The first comparative heater 200A is a socket pressing type heater. For example, the first comparative heater 200A includes a tubular bulb 201, a filament 202, a metallic foil 203, a wire 204, and a terminal 205. The filament 202 is disposed inside the bulb 201 and coiled in a longitudinal direction of the bulb 201. The metallic foil 203 is coupled to each lateral end of the filament 202 in a longitudinal direction thereof. The wire 204 is coupled to the metallic foil 203. The terminal 205 is coupled to the wire 204.

The metallic foil 203 is connected to the filament 202 through an interior lead 206. The metallic foil 203 is connected to the terminal 205 through an exterior lead 207 of the wire 204. A plurality of supporters 208 is disposed in the longitudinal direction of the bulb 201. The supporters 208 support the filament 202 such that the filament 202 is coaxial with the bulb 201. Each lateral end of the bulb 201 in the longitudinal direction thereof is sealed so that the bulb 201 is filled with inert gas. A seal 209 is disposed at each lateral end of the bulb 201 in the longitudinal direction thereof and accommodates the metallic foil 203. The exterior lead 207 coupled to the metallic foil 203 includes an exposed lateral end exposed from the seal 209 to an outside of the bulb 201. The terminal 205 is coupled to the exposed lateral end of the exterior lead 207. A ceramic cover 210 covers the exposed lateral end of the exterior lead 207 and the terminal 205.

As the terminal 205 is pressed against a contact 211 connected to a power supply, the power supply is ready to supply power to the filament 202. As the power supply supplies power to the filament 202, the filament 202 generates heat.

However, if connection between the terminal 205 and the contact 211 degrades due to vibration or the like, power may not be supplied to the filament 202 properly, degrading safety of the first comparative heater 200A.

FIG. 4 is a schematic perspective view of a second comparative heater 200B. Unlike the first comparative heater 200A depicted in FIG. 3 being the socket pressing type heater, the second comparative heater 200B is a screw securing type heater that includes a hole 212 penetrating through a terminal 205B. A screw threaded through the hole 212 fastens the terminal 205B to the second comparative heater 200B. Since the terminal 205B is secured to the second comparative heater 200B with the screw, the terminal 205B contacts a contact of the power supply constantly and precisely.

FIG. 5 is a schematic perspective view of a third comparative heater 200C. The third comparative heater 200C is a harness type heater that includes a harness 213 that couples the exterior lead 207 to a terminal 205C. The exterior lead 207 and the harness 213 constitute a wire 204C. Like the terminal 205B secured to the second comparative heater 200B with the screw as illustrated in FIG. 4, the terminal 205C is secured to the third comparative heater 200C with a screw through the hole 212. Accordingly, the terminal 205C contacts the contact of the power supply constantly and precisely.

In FIGS. 4 and 5, identical reference numerals are assigned to components of the second comparative heaters 200B and the third comparative heater 200C that are equivalent to the components of the first comparative heater 200A depicted in FIG. 3 in construction and function. A description of the components having the identical reference numerals is omitted.

As described above, the screw securing type, second comparative heater 200B depicted in FIG. 4 and the harness type, third comparative heater 200C depicted in FIG. 5 are superior to the socket pressing type, first comparative heater 200A depicted in FIG. 3 in conductivity and safety. However, the third comparative heater 200C may be elongated in a longitudinal direction thereof and upsized. To address this circumstance, the interior lead 206 may be shortened, for example. However, an interval between the filament 202 and the metallic foil 203 may be shortened, accelerating thermal degradation of the metallic foil 203. Additionally, the shortened interior lead 206 may cause the metallic foil 203 to be situated inside a fixing roller. Accordingly, the metallic foil 203 may be susceptible to a high temperature environment and thermal degradation.

As described above, each of the first comparative heater 200A, the second comparative heater 200B, and the third comparative heater 200C includes a wire (e.g., the wires 204 and 204C) and a terminal (e.g., the terminals 205, 205B, and 205C) that extend from each lateral end of the bulb 201 in the longitudinal direction thereof. Accordingly, each of the first comparative heater 200A, the second comparative heater 200B, and the third comparative heater 200C is requested to spare an installation space situated outboard from the bulb 201 in the longitudinal direction thereof to accommodate the wire and the terminal. Consequently, each of the first comparative heater 200A, the second comparative heater 200B, and the third comparative heater 200C may upsize a fixing device that accommodates each of the first comparative heater 200A, the second comparative heater 200B, and the third comparative heater 200C.

To address this circumstance, the heater 18 of the fixing device 13 depicted in FIG. 2 has a configuration described below.

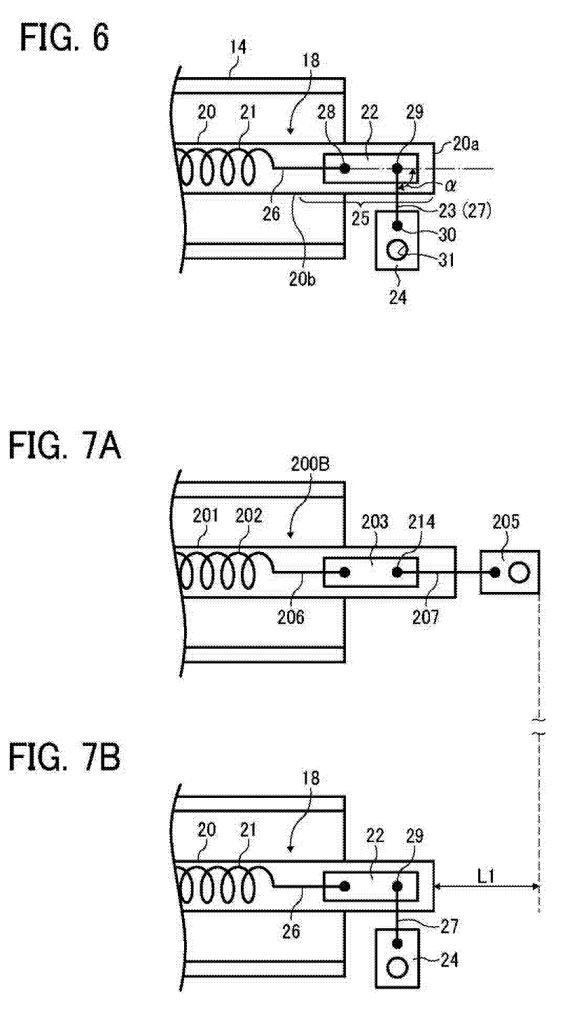

FIG. 6 is a schematic cross-sectional view of the heater 18. The heater 18 is a halogen heater of the screw securing type. For example, as illustrated in FIG. 6, the heater 18 includes, as main components, a tubular or cylindrical bulb 20, a filament 21, a metallic foil 22, a wire 23, and a terminal 24. The filament 21 serving as a heat generator is disposed inside the bulb 20. The metallic foil 22 is coupled to each lateral end of the filament 21 in a longitudinal direction thereof The wire 23 is coupled to the metallic foil 22. The terminal 24 is coupled to the wire 23.

A detailed description is now given of a configuration of the bulb 20.

The bulb 20 is a straight tube made of quartz glass or the like. A seal 25 disposed at each lateral end of the bulb 20 in a longitudinal direction thereof seals the bulb 20 so that the bulb 20 is filled with inert gas.

A detailed description is now given of a configuration of the filament 21.

filament 21 includes a coiled metallic wire made of tungsten or the like. The filament 21 disposed inside the bulb 20 extends along the longitudinal direction of the bulb 20.

A plurality of supporters (e.g., the supporters 208 depicted in FIG. 3) supports the filament 21 such that the filament 21 is coaxial with the bulb 20.

A detailed description is now given of a configuration of the metallic foil 22.

The metallic foil 22 is a rectangular, thin plate made of molybdenum and disposed inside the seal 25 of the bulb 20. An inner end (e.g., a left end in FIG. 6) of the metallic foil 22 is connected to the filament 21 through an interior lead 26. Conversely, an outer end (e.g., a right end in FIG. 6) of the metallic foil 22 is connected to the terminal 24 through an exterior lead 27 serving as the wire 23. The interior lead 26 is coupled to the metallic foil 22 at a contact 28 by spot welding. The exterior lead 27 is coupled to the metallic foil 22 at a contact 29 by spot welding. The exterior lead 27 is coupled to the terminal 24 at a contact 30 by spot welding.

A detailed description is now given of a configuration of the terminal 24.

The terminal 24 is a rectangular metal plate having a hole 31 (e.g., a through-hole) through which a screw fastens the terminal 24 to the heater 18. For example, the terminal 24 is fastened to a heater holder or the like situated in the fixing device 13 or the image forming apparatus 100 with the screw inserted into the hole 31. As the screw fastens the terminal 24 to the heater holder, the terminal 24 is secured to the heater holder in a state in which the terminal 24 contacts a contact connected to a power supply. As the terminal 24 disposed at each lateral end of the heater 18 in a longitudinal direction thereof is secured to the heater holder and the heater 18 is installed inside the fixing roller 14 as illustrated in FIG. 6, a part of the seal 25 sealing the bulb 20, a part of the metallic foil 22, and the terminal 24 are exposed and projected from each lateral end of the fixing roller 14 in an axial direction thereof to an outside of the fixing roller 14.

Unlike the exterior lead 207 depicted in FIGS. 3, 4, and 5, the exterior lead 27 according to this exemplary embodiment extends from the contact 29 where the exterior lead 27 contacts the metallic foil 22 in a direction (e.g., a downward direction in FIG. 6) perpendicular or substantially perpendicular to the longitudinal direction (e.g., a rightward direction in FIG. 6) of the bulb 20. The exterior lead 27 is exposed from the seal 25 to an outside of the bulb 20. In other words, the exterior lead 27 does not project from an outermost end 20a, that is, a lateral edge, of the bulb 20 in the longitudinal direction thereof. The exterior lead 27 projects from a side face 20b of the bulb 20 to the outside of the bulb 20 in the direction perpendicular to the longitudinal direction of the bulb 20. The side face 20b is inboard from the outermost end 20a in the longitudinal direction of the bulb 20. Accordingly, the heater 18 is shorter than the first comparative heater 200A, the second comparative heater 200B, and the third comparative heater 200C in the longitudinal direction of the heater 18.

A description is provided of a first comparison between the heater 18 and the second comparative heater 200B.

FIG. 7A is a schematic cross-sectional view of the second comparative heater 200B of the screw securing type for explaining the first comparison. FIG. 7B is a schematic cross-sectional view of the heater 18 according to this exemplary embodiment for explaining the first comparison.

As illustrated in FIG. 7A, the exterior lead 207 of the second comparative heater 200B extends from a contact 214 where the exterior lead 207 contacts the metallic foil 203 in the longitudinal direction of the bulb 201. Accordingly, the entire second comparative heater 200B may elongate in a longitudinal direction thereof.

Conversely, as illustrated in FIG. 7B, the exterior lead 27 of the heater 18 extends from the contact 29 where the exterior lead 27 contacts the metallic foil 22 in the direction perpendicular or substantially perpendicular to the longitudinal direction of the bulb 20. Accordingly, the entire heater 18 may be shorter than the entire second comparative heater 200B by a length L1 in the longitudinal direction of the heater 18. If the exterior lead 27 disposed at each lateral end of the heater 18 in the longitudinal direction thereof extends in the direction perpendicular or substantially perpendicular to the longitudinal direction of the bulb 20, the heater 18 is shorter than the second comparative heater 200B by a combined length defined by combination of the length L1 at one lateral end of the heater 18 and the length L1 at another lateral end of the heater 18 in the longitudinal direction thereof. Thus, the heater 18 according to this exemplary embodiment is shortened and downsized compared to the second comparative heater 200B.

A description is provided of a second comparison between the heater 18 and the second comparative heater 200B.

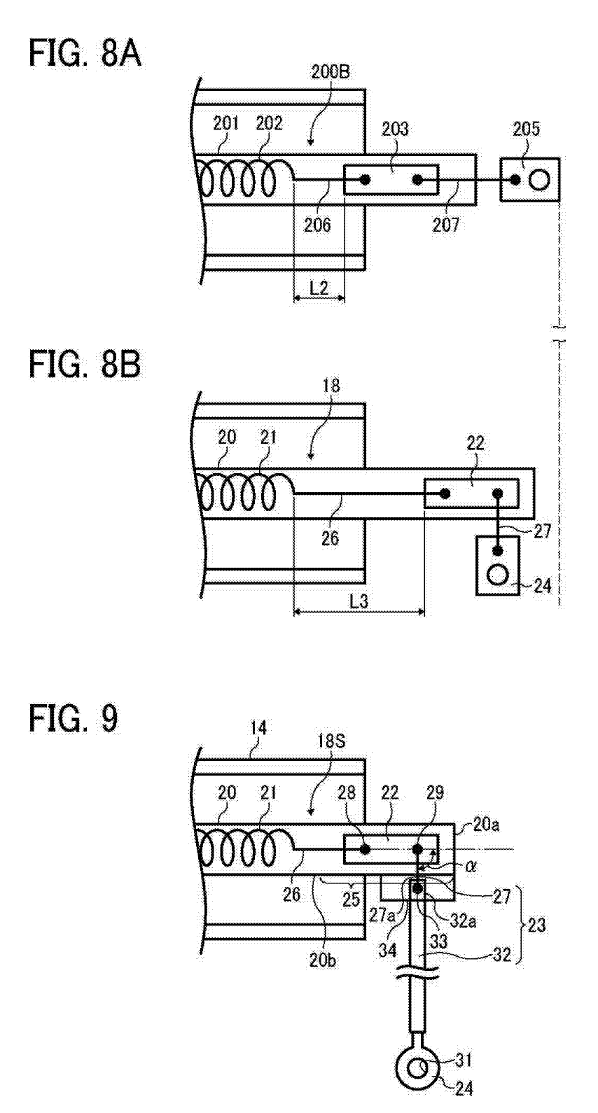

FIG. 8A is a schematic cross-sectional view of the second comparative heater 200B for explaining the second comparison. FIG. 8B is a schematic cross-sectional view of the heater 18 according to this exemplary embodiment for explaining the second comparison. As illustrated in FIG. 8B, while the exterior lead 27 extending in the direction perpendicular or substantially perpendicular to the longitudinal direction of the bulb 20 shortens the entire heater 18 in the longitudinal direction thereof compared to the entire second comparative heater 200B depicted in FIG. 8A, the exterior lead 27 allows the interior lead 26 to have an increased length L3 greater than a length L2 of the interior lead 206 of the second comparative heater 200B. Accordingly, the metallic foil 22 and peripheral components disposed in proximity to the metallic foil 22 are isolated from the filament 21 with an increased interval therebetween, suppressing thermal degradation of the metallic foil 22 and the peripheral components. Thus, while the exterior lead 27 prevents the heater 18 from being elongated compared to the second comparative heater 200B, the exterior lead 27 suppresses thermal degradation of the metallic foil 22 and the peripheral components, extending the life of the heater 18.

A description is provided of a configuration of a heater 18S according to another exemplary embodiment.

FIG. 9 is a schematic cross-sectional view of the heater 18S. The following describes a configuration of the heater 18S that is different from the configuration of the heater 18 described above and a description of a configuration of the heater 18S that is identical to the configuration of the heater 18 is omitted.

In the heater 18 illustrated in FIG. 6, the metallic foil 22 and the terminal 24 are connected to the exterior lead 27 directly. Conversely, in the heater 18S illustrated in FIG. 9, the metallic foil 22 is connected to the terminal 24 through the exterior lead 27 and a harness 32. That is, the heater 18S is a halogen heater of the harness type. For example, one end of the exterior lead 27 is coupled to an outer end (e.g., a right end in FIG. 9) of the metallic foil 22. Another end of the exterior lead 27 is coupled to a first end of the harness 32 opposite a second end of the harness 32 coupled with the circular terminal 24. The exterior lead 27 is coupled to the harness 32 at a contact 33 by spot welding. A ceramic cover 34 covers an exposed portion 27a of the exterior lead 27 exposed and projected from the seal 25 and an end portion 32a of the harness 32 that is coupled to the exposed portion 27a of the exterior lead 27.

Like the exterior lead 27 of the heater 18 depicted in FIG. 6, the exterior lead 27 of the heater 18S depicted in FIG. 9 extends from the contact 29 where the exterior lead 27 contacts the metallic foil 22 in the direction perpendicular or substantially perpendicular to the longitudinal direction of the bulb 20. The exterior lead 27 projects from the side face 20b of the bulb 20 to the outside of the bulb 20. Similarly, the harness 32 extends in the direction perpendicular or substantially perpendicular to the longitudinal direction of the bulb 20.

A description is provided of a third comparison between the heater 18S and the third comparative heater 200C of the harness type.

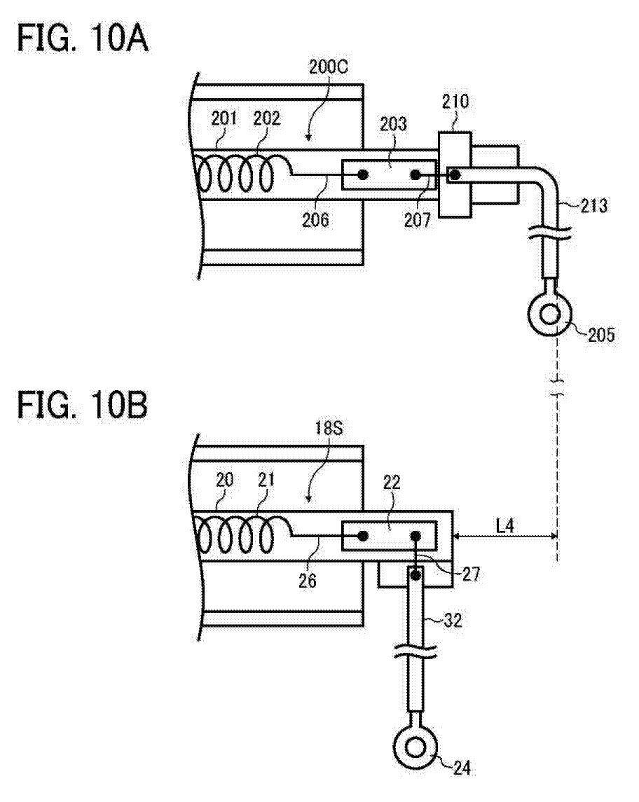

FIG. 10A is a schematic cross-sectional view of the third comparative heater 200C for explaining the third comparison. FIG. 10B is a schematic cross-sectional view of the heater 18S according to this exemplary embodiment for explaining the third comparison. As illustrated in FIG. 10B, the exterior lead 27 and the harness 32 extending in the direction perpendicular or substantially perpendicular to the longitudinal direction of the bulb 20 shorten the entire heater 18S by a length L4 in a longitudinal direction thereof compared to the entire third comparative heater 200C depicted in FIG. 10A. Since the exterior lead 27 and the harness 32 disposed at each lateral end of the heater 18S in the longitudinal direction thereof extend in the direction perpendicular or substantially perpendicular to the longitudinal direction of the bulb 20, the heater 18S is shorter than the third comparative heater 200C by a combined length defined by combination of the length L4 at one lateral end of the heater 18S and the length L4 at another lateral end of the heater 18S in the longitudinal direction thereof. Thus, the heater 18S according to this exemplary embodiment is shortened and downsized compared to the third comparative heater 200C.

A description is provided of a fourth comparison between the heater 18S and the third comparative heater 200C.

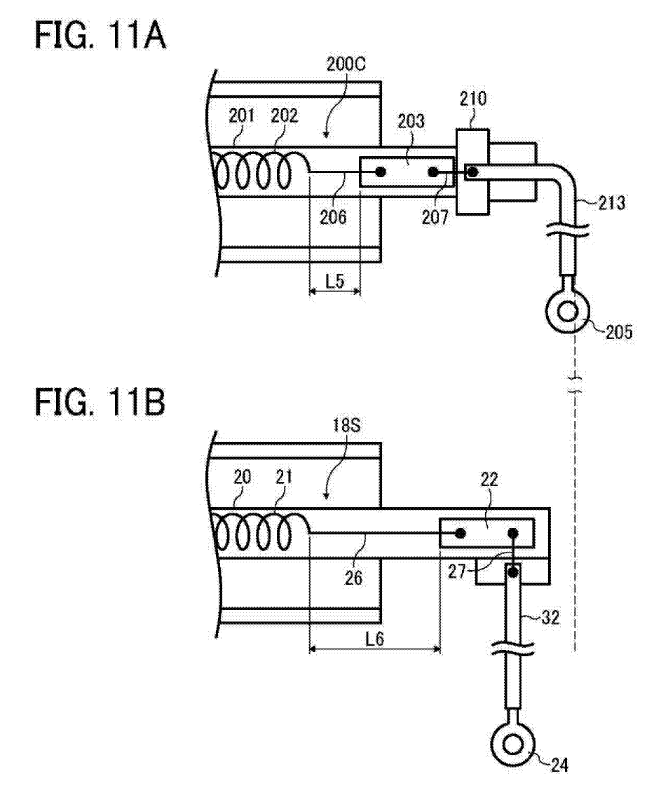

FIG. 11A is a schematic cross-sectional view of the third comparative heater 200C for explaining the fourth comparison. FIG. 11B is a schematic cross-sectional view of the heater 18S according to this exemplary embodiment for explaining the fourth comparison. As illustrated in FIG. 11B, while the exterior lead 27 and the harness 32 extending in the direction perpendicular or substantially perpendicular to the longitudinal direction of the bulb 20 shorten the entire heater 18S in the longitudinal direction thereof compared to the entire third comparative heater 200C depicted in FIG. 11A, the exterior lead 27 and the harness 32 allow the interior lead 26 to have a length L6 greater than a length L5 of the interior lead 206 of the third comparative heater 200C. Thus, like the exterior lead 27 of the heater 18, while the exterior lead 27 and the harness 32 of the heater 18S prevent the heater 18S from being elongated compared to the third comparative heater 200C, the exterior lead 27 and the harness 32 suppress thermal degradation of the metallic foil 22 and the peripheral components, extending the life of the heater 18S.

As described above, if the wire 23 constructed of the exterior lead 27 as illustrated in FIG. 6 or the wire 23 constructed of the exterior lead 27 and the harness 32 as illustrated in FIG. 9 that is disposed at each lateral end of the heater 18 or 18S in the longitudinal direction thereof extends in an intersecting direction intersecting the longitudinal direction of the bulb 20, the heater 18 or 18S is further shortened in the longitudinal direction thereof compared to a configuration in which the wire 23 disposed at one lateral end of the heater 18 or 18S in the longitudinal direction thereof extends in the intersecting direction intersecting the longitudinal direction of the bulb 20. However, if the wire 23 disposed at each lateral end of the heater 18 or 18S in the longitudinal direction thereof extends in the intersecting direction intersecting the longitudinal direction of the bulb 20, the heater 18 or 18S may not be inserted into the fixing roller 14 smoothly. To address this circumstance, the wire 23 disposed at one lateral end of the heater 18 or 18S in the longitudinal direction thereof extends in the intersecting direction intersecting the longitudinal direction of the bulb 20 and the wire 23 disposed at another lateral end of the heater 18 or 18S in the longitudinal direction thereof extends in the longitudinal direction of the bulb 20. Accordingly, the heater 18 or 18S is inserted into the fixing roller 14 readily through another lateral end of the heater 18 or 18S in the longitudinal direction thereof, facilitating installation of the heater 18 or 18S.

If a space is spared for a driver (e.g., a gear) that drives and rotates the fixing roller 14 and the pressure roller 15 and is disposed at one lateral end of the fixing roller 14 and the pressure roller 15 in an axial direction thereof, the wire 23 extending in the longitudinal direction of the bulb 20 is situated in the space at a position in proximity to the driver, facilitating installation of the heater 18 or 18S without upsizing the fixing device 13.

The present disclosure is not limited to the details of the exemplary embodiments described above and various modifications and improvements are possible.

As illustrated in FIGS. 6 and 9, the direction in which the wire 23 extends and the longitudinal direction of the bulb 20 define an angle α of 90 degrees or about 90 degrees. Alternatively, the angle α may be 80 degrees, 70 degrees, or other degrees in accordance with the layout of parts of the heaters 18 and 18S and the fixing device 13 or the like. The wire 23 extends from the contact 29 where the wire 23 contacts the metallic foil 22 in the intersecting direction intersecting the longitudinal direction of the bulb 20 instead of a direction parallel to the longitudinal direction of the bulb 20 unlike the first comparative heater 200A, the second comparative heater 200B, and the third comparative heater 200C depicted in FIGS. 3, 4, and 5, respectively, thus shortening the length of the heaters 18 and 18S in the longitudinal direction thereof.

As illustrated in FIG. 2, the heater 18 is disposed inside the fixing roller 14. Alternatively, the heaters 18 and 18S may be disposed outside the fixing roller 14 or disposed inside or outside the pressure roller 15. Yet alternatively, the heaters 18 and 18S may be disposed inside or outside the paper tray 9 depicted in FIG. 1 to heat and dehumidify the sheet P placed on the paper tray 9 before the sheet P is conveyed to the process unit 1 serving as an image forming device.

A description is provided of advantages of the heaters 18 and 18S.

As illustrated in FIGS. 6 and 9, a heater (e.g., the heaters 18 and 18S) includes a tubular bulb (e.g., the bulb 20); a filament (e.g., the filament 21) disposed inside the bulb and extended in a longitudinal direction of the bulb; a first metallic foil (e.g., the metallic foil 22) coupled to one lateral end of the filament in the longitudinal direction of the bulb; a second metallic foil (e.g., the metallic foil 22) coupled to another lateral end of the filament in the longitudinal direction of the bulb; a first wire (e.g., the wire 23) coupled to the first metallic foil at a first contact (e.g., the contact 29); a second wire (e.g., the wire 23) coupled to the second metallic foil at a second contact (e.g., the contact 29); a first terminal (e.g., the terminal 24) coupled to the first wire; and a second terminal (e.g., the terminal 24) coupled to the second wire. At least one of the first wire and the second wire, for example, the first wire, extends from the first contact in an intersecting direction intersecting the longitudinal direction of the bulb.

The first wire extending from the first contact in the intersecting direction intersecting the longitudinal direction of the bulb shortens the length of the heater in the longitudinal direction of the bulb. The first wire allows the first metallic foil and peripheral components disposed in proximity to the first metallic foil to be isolated from the filament with an increased interval therebetween, suppressing thermal degradation of the first metallic foil and the peripheral components while preventing the heater from being elongated in the longitudinal direction of the bulb.

Although FIGS. 6 and 9 illustrate the first metallic foil, the first wire, and the first terminal disposed at one lateral end of the heater in a longitudinal direction thereof, the second metallic foil, the second wire, and the second terminal are disposed at another lateral end of the heater in the longitudinal direction thereof symmetrically to the first metallic foil, the first wire, and the first terminal.

According to the exemplary embodiments described above, the fixing roller 14 serves as a fixing rotator. Alternatively, a fixing belt, a fixing film, a fixing sleeve, or the like may be used as a fixing rotator. Further, the pressure roller 15 serves as a pressure rotator. Alternatively, a pressure belt or the like may be used as a pressure rotator.

The present disclosure has been described above with reference to specific exemplary embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative exemplary embodiments may be combined with each other and/or substituted for each other within the scope of the present disclosure.

What is claimed is:

1. A heater comprising:
a tubular bulb;
a filament disposed inside the bulb and extended in a longitudinal direction of the bulb;
a first metallic foil coupled to one lateral end of the filament in the longitudinal direction of the bulb;
a second metallic foil coupled to another lateral end of the filament in the longitudinal direction of the bulb;
a first wire coupled to the first metallic foil at a first contact, the first wire extending from the first contact in an intersecting direction intersecting the longitudinal direction of the bulb; and
a second wire coupled to the second metallic foil at a second contact.

2. The heater according to claim 1, further comprising:
a first terminal coupled to the first wire; and
a second terminal coupled to the second wire.

3. The heater according to claim 2,
wherein the first wire includes an exterior lead coupled to the first metallic foil and the first terminal directly.

4. The heater according to claim 2,
wherein the first wire includes:
an exterior lead coupled to the first metallic foil; and
a harness coupled to the exterior lead and the first terminal.

5. The heater according to claim 4,
wherein the exterior lead and the harness extend in a direction substantially perpendicular to the longitudinal direction of the bulb.

6. The heater according to claim 4, further comprising a seal, disposed at each lateral end of the bulb in the longitudinal direction thereof, to seal the bulb.

7. The heater according to claim 6,
wherein the exterior lead includes an exposed portion exposed from the seal to an outside of the bulb.

8. The heater according to claim 7, further comprising a ceramic cover covering the exposed portion of the exterior lead,
wherein the harness includes an end portion coupled to the exposed portion of the exterior lead and covered by the ceramic cover.

9. The heater according to claim 1,
wherein the intersecting direction is perpendicular to the longitudinal direction of the bulb.

10. The heater according to claim 1,
wherein the intersecting direction is substantially perpendicular to the longitudinal direction of the bulb.

11. The heater according to claim 1,
wherein the intersecting direction and the longitudinal direction of the bulb define an angle of one of 70 degrees, 80 degrees, and 90 degrees.

12. The heater according to claim 1,
wherein the second wire extends from the second contact in the longitudinal direction of the bulb.

13. The heater according to claim 1,
wherein the second wire extends from the second contact in the intersecting direction intersecting the longitudinal direction of the bulb.

14. The heater according to claim 1,
wherein the bulb includes an outermost end in the longitudinal direction of the bulb, and
wherein the first wire is disposed inboard from the outermost end of the bulb in the longitudinal direction of the bulb.

15. The heater according to claim 14,
wherein the bulb further includes a side face disposed inboard from the outermost end of the bulb in the longitudinal direction thereof, and
wherein the first wire projects from the side face of the bulb to an outside of the bulb.

16. The heater according to claim 1, further comprising an interior lead through which the first metallic foil is coupled to the filament.

17. The heater according to claim 16, wherein the interior lead has an increased length in the longitudinal direction of the bulb to isolate the first metallic foil from the filament with an increased interval therebetween.

18. A fixing device comprising:
a fixing rotator rotatable in a predetermined direction of rotation;
a pressure rotator pressed against the fixing rotator to form a fixing nip therebetween, the fixing nip through which a recording medium bearing a toner image is conveyed; and
a heater to heat the fixing rotator,
the heater including:
a tubular bulb;
a filament disposed inside the bulb and extended in a longitudinal direction of the bulb;
a first metallic foil coupled to one lateral end of the filament in the longitudinal direction of the bulb;
a second metallic foil coupled to another lateral end of the filament in the longitudinal direction of the bulb;
a first wire coupled to the first metallic foil at a first contact, the first wire extending from the first contact in an intersecting direction intersecting the longitudinal direction of the bulb; and
a second wire coupled to the second metallic foil at a second contact.

19. The fixing device according to claim 18,
wherein the fixing rotator includes a fixing roller and the pressure rotator includes a pressure roller.

20. An image forming apparatus comprising:
an image forming device to form a toner image; and
a fixing device disposed downstream from the image forming device in a recording medium conveyance direction to fix the toner image on a recording medium,
the fixing device including:
a fixing rotator rotatable in a predetermined direction of rotation;
a pressure rotator pressed against the fixing rotator to form a fixing nip therebetween, the fixing nip through which the recording medium bearing the toner image is conveyed; and
a heater to heat the fixing rotator,
the heater including:
a tubular bulb;
a filament disposed inside the bulb and extended in a longitudinal direction of the bulb;
a first metallic foil coupled to one lateral end of the filament in the longitudinal direction of the bulb;
a second metallic foil coupled to another lateral end of the filament in the longitudinal direction of the bulb;
a first wire coupled to the first metallic foil at a first contact, the first wire extending from the first contact in an intersecting direction intersecting the longitudinal direction of the bulb; and
a second wire coupled to the second metallic foil at a second contact.
